(19) United States
(12) Patent Application Publication
(10) Pub. No.: US 2024/0203046 A1
(43) Pub. Date: Jun. 20, 2024

(54) DYNAMIC MODIFICATION OF VIRTUAL REALITY (VR) ENVIRONMENT REPRESENTATIONS USED IN A VR COLLABORATION SESSION

(71) Applicant: International Business Machines Corporation, Armonk, NY (US)

(72) Inventors: Sarbajit K. Rakshit, Kolkata (IN); Sudheesh S. Kairali, Kozhikode (IN); Satyam Jakkula, Bengaluru (IN); Binoy Thomas, Kozhikode (IN)

(21) Appl. No.: 18/081,548

(22) Filed: Dec. 14, 2022

(51) Int. Cl. G06T 17/00; G06F 3/01; G06F 3/16; G06T 13/20; G06T 13/40

(52) U.S. Cl. CPC G06T 17/00; G06F 3/017; G06F 3/167; G06T 13/205; G06T 13/40

(57) ABSTRACT

A computer-implemented method, according to one embodiment, includes outputting a first virtual reality (VR) environment representation for display on a plurality of VR devices. First inputs received from participants using the VR devices are analyzed to determine whether to output a second VR environment representation. The method further includes determining, based on the analysis, a second VR environment representation and a first transitional sequence for the VR devices to output while transitioning from displaying the first VR environment representation to displaying the second VR environment representation. The second VR environment representation and the first transitional sequence are output for display on the VR devices. In response to a determination that a first of the participants has performed a predetermined gesture, a second transitional sequence for the VR devices to output while transitioning from the second VR environment representation back to the first VR environment representation is output.

### BACKGROUND

The present invention relates to virtual reality (VR), and more specifically, this invention relates to dynamic modification of VR environment representations used in a VR collaboration session.

VR collaboration platforms allow users, e.g., participants of a VR collaboration session, to collaborate from different remote locations at which the users are physically located. For context, the VR collaboration platforms may host a plurality of users each using a VR device, e.g., VR glasses, to participate in a VR collaboration session. VR collaboration enables users to meet up in the same virtual space and communicate through both speech and text. VR collaboration platforms offer users the ability to choose and edit avatars to represent their likeness as well as custom environments to host a virtual meetup. Within virtual meetups users can host virtual presentations, collaborate together, and socialize on team projects.

### SUMMARY

A computer-implemented method according to one embodiment includes outputting a first virtual reality (VR) environment representation for display on a plurality of VR devices associated with a VR collaboration session. Each of the VR devices is used by a different participant of the VR collaboration session. First inputs received from the participants are analyzed to determine whether to output a second VR environment representation for display on the plurality of VR devices. The method further includes determining, based on the analysis, a second VR environment representation and a first transitional sequence for the VR devices to output while transitioning from displaying the first VR environment representation to displaying the second VR environment representation. The second VR environment representation and the first transitional sequence are output for display on the VR devices. In response to a determination that a first of the participants has performed a predetermined gesture, a second transitional sequence for the VR devices to output while transitioning from the second VR environment representation back to the first VR environment representation is output.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIGS. 3A-3H depict representations of progression of a VR collaboration session, in accordance with various embodiments.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for dynamic modification of VR environment representations used in a VR collaboration session.

In one general embodiment, a computer-implemented method includes outputting a first virtual reality (VR) environment representation for display on a plurality of VR devices associated with a VR collaboration session. Each of the VR devices is used by a different participant of the VR collaboration session. First inputs received from the participants are analyzed to determine whether to output a second VR environment representation for display on the plurality of VR devices. The method further includes determining, based on the analysis, a second VR environment representation and a first transitional sequence for the VR devices to output while transitioning from displaying the first VR environment representation to displaying the second VR environment representation. The second VR environment representation and the first transitional sequence are output for display on the VR devices. In response to a determination that a first of the participants has performed a predetermined gesture, a second transitional sequence for the VR devices to output while transitioning from the second VR environment representation back to the first VR environment representation is output.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as VR environment representation modification module of block 200 for dynamically modifying VR environment representations used in a VR collaboration session. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

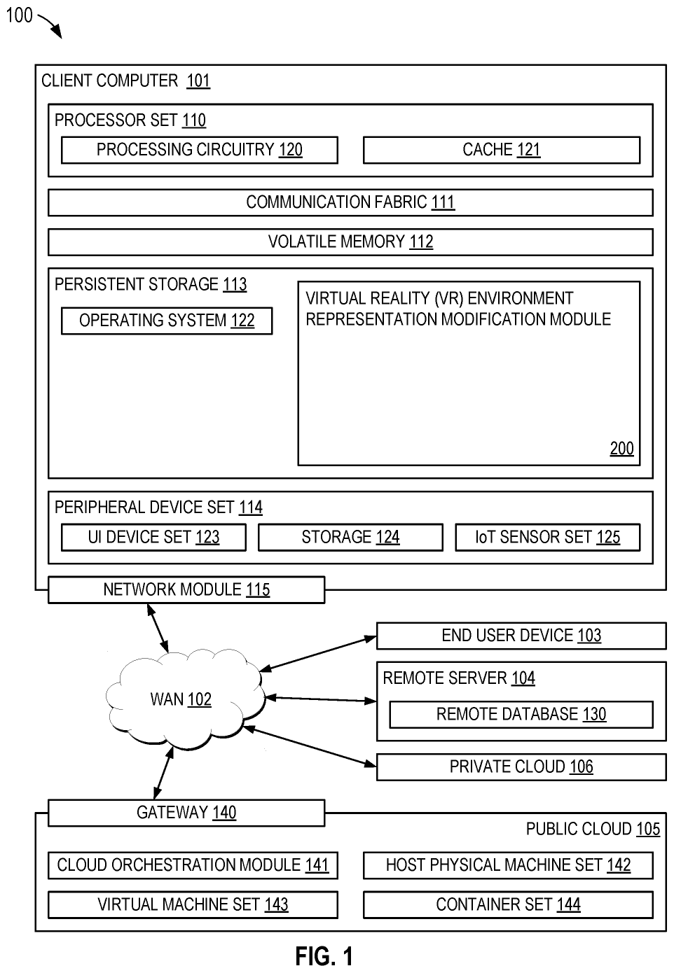

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, VR collaboration platforms allow users, e.g., participants of a VR collaboration session, to collaborate from different remote locations at which the users are physically located. For context, the VR collaboration platforms may host a plurality of users each using a VR device, e.g., VR glasses, to participate in a VR collaboration session. VR collaboration enables users to meet up in the same virtual space and communicate through both speech and text. VR collaboration platforms offer users the ability to choose and edit avatars to represent their likeness as well as custom environments to host a virtual meetup. Within virtual meetups users can host virtual presentations, collaborate together, and socialize on team projects.

Use of VR collaboration sessions will continue following a recent shift in the global workforce toward remote work positions and hybrid work from home positions, where people will be collaborating with each other in virtual environments. However, conventional VR collaboration sessions fail to dynamically incorporate contexts associated with user gestures and/or conversations into a VR environment representation that is output for display on a display of the participant's VR devices. For example, in a first VR collaboration session, participants may be collaborating on a design thinking workshop. However, in the event that a first of the participants wants to show a second participant a VR environment representation, e.g., such as the first participant's last travel story, new house, etc., conventional VR collaboration sessions do not include features that accommodate this to occur. Accordingly, to enhance user experience, there is a need for participants to be able to initiate a currently displayed VR environment representation to be modified with transition effects to a different VR environment representation.

In sharp contrast to the deficiencies described above, techniques of various embodiments and approaches described herein enable dynamic modification of VR environment representations used in a VR collaboration session, based on analysis of user inputs, e.g., such as gestures, conversation context, etc.

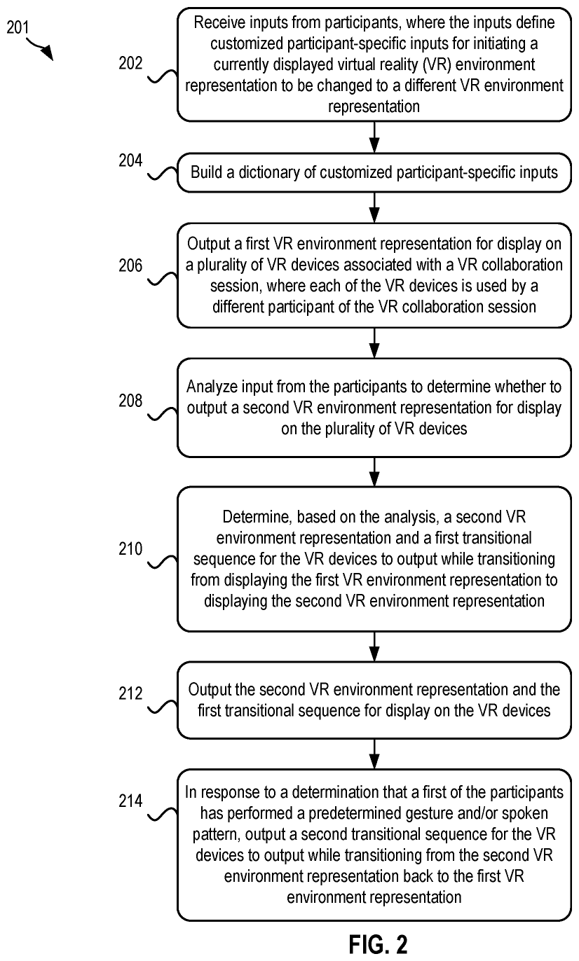

Now referring to FIG. 2, a flowchart of a method 201 is shown according to one embodiment. The method 201 may be performed in accordance with the present invention in any of the environments depicted in FIGS. 1-3H, among others, in various embodiments. Of course, more or fewer operations than those specifically described in FIG. 2 may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 201 includes techniques for enabling dynamic modification of VR environment representations used in a VR collaboration session. Such a VR collaboration session may be hosted on a predetermined VR collaboration session hosting platform and/or an application associated therewith. Each of a plurality of participants may virtually attend the VR collaboration session using a VR device. For context, the VR devices may include a known type of VR viewing devices, e.g., such as augmented reality (AR) glasses, a device display, VR glasses, a front facing camera device that captures body movement of an associated participant using the VR device, a display device with a camera and/or microphone, etc. In some approaches, body movement of the participants may additionally and/or alternatively be captured by body wearable devices, e.g., such as a smartwatch, etc. In some preferred approaches, the VR devices are configured to display a real world three-dimensional (3D) perspective of a geographical location that a VR environment representation output is based on. More specifically, a VR environment representation may be output to each of the participants of a VR collaboration session for display on the plurality of VR devices. For example, assuming that the VR environment representation is based on a conference room located at a predetermined office, subsequent to the VR environment representation being output to the VR devices, the VR devices may display the VR environment representation on a display of the VR devices. This way, participants viewing the VR environment representation on a display of the VR devices may have an impression of actually being in the conference room.

In some approaches, a VR environment representation may include an avatar for each of the participants of the VR collaboration session. These avatars may be cartoon based avatars and/or modeled on an actual physical appearance of the participants of the VR collaboration session. Moreover, each of the avatars may imitate actual physical movements that an associated one of the participants makes. This way, each of the participants may form an impression of actually being in the meeting room with the other participants on the VR collaboration session. Because the VR environment representation may be a representation of an actual geographical location, in some approaches, the VR environment representation may additionally and/or alternatively include all or less than all of the contents, e.g., machines, obstacles, clarity, light, etc., that actually exist in the geographical location that the VR environment representation is based on. The VR device may additionally and/or alternatively include hand-held control(s) to control arms of an avatar in the VR environment representation. Furthermore, the VR device may additionally and/or alternatively include components configured to generate taste and/or smell samples to be emitted as a scent and/or flavor sample for the participant to consume in order to further experience tastes and/or smells associated with an environment, e.g., a classroom, a conference room, an outdoor setting, an indoor setting, a sports arena, outer space, underwater, etc., that the VR environment representation is based on.

Inputs may be received from participants that use VR devices to virtually attend VR collaboration sessions, e.g., see operation 202. Such input may, in some approaches, define customized participant-specific inputs for initiating a currently displayed virtual reality (VR) environment representation to be changed to a different VR environment representation. It may be noted that, various examples of such inputs will be described elsewhere herein, e.g., see operation 208 and/or operation 214. A dictionary of customized participant-specific inputs may be built, e.g., see operation 204, which may be referenced while analyzing behavior of an associated participant in order to determine whether to modify and/or change a VR environment representation currently displayed on VR devices of a VR collaboration session. This way, participants can select various predefined gestures, body language, etc., which may be translated to an associated avatar and initiate a transition between different VR environment representations. The dictionary may, in some approaches, be associated with a predetermined library of VR environment representations that are determined based on gestures of one or more of the participants. The participants may additionally and/or alternatively select different visual appearances for their associated avatar, and map these with their gestures, body language, etc. These customized participant-specific inputs may be adjusted or changed at any time.

Operation 206 includes outputting a first VR environment representation for display on a plurality of VR devices associated with a VR collaboration session. Each of the VR devices may be used by a different human participant of the VR collaboration session, e.g., to view and virtually interact within the first VR environment representation. The first VR environment representation may include an avatar for each of the participants. In some approaches, one or more of the avatars may be cartoon representations based on a physical appearance of the participants. However, despite such cartoon avatars being included in the first VR environment representation, the first VR environment representation may be a real-world depiction of a geographical location and not a cartoon animation of the geographical location. In some other approaches, one or more of the avatars may physically resemble an actual appearance associated with one of the participants and/or the first VR environment representation may be a cartoon animation of a predetermined location.

Operation 208 includes analyzing first inputs received from at least one of the participants during display of the first VR environment representation on the plurality of VR devices to determine whether to output a second VR environment representation for display on the plurality of VR devices. This way, the VR environment representation displayed on VR devices is dynamically adjusted based on the participants. In some approaches, the second VR environment representation may be a volumetric video, or any other format of VR contents. Each and every instance of VR content may be identified uniquely and may be identifying with context of volumetric content.

It should be noted that any monitoring of the participants data and/or behavior is preferably only performed subsequent to obtaining permission from the participant, e.g., an opt-in pre-requisite. For context, the inputs may, in some approaches, be received as audio data that one or more of the participants speak into a microphone of an associated VR device. Accordingly, in one or more of such approaches, the analysis may include determining whether predetermined audio, e.g., words, an auditory spoken pattern of language, phrases, sounds, tones, etc., has been emitted by one or more of the participants and/or background noise of one or more of the participants. This predetermined audio may be pre-associated with a second VR environment representation. For example, in some approaches the predetermined audio may mention a setting, e.g., a geographical location, a picture, a planet, a landmark, etc. Physical gestures made by one or more of the participants may additionally and/or alternatively be considered during the analysis. For example, in one or more of such approaches, the analysis may include determining whether predetermined audio, e.g., words, phrases, sounds, tones, etc., has been made by one or more of the participants. The first inputs may, additionally and/or alternatively, include a gesture performed by one of the participants, e.g., pointing to a location on a map, entering text into a search bar, performing a dance associated with a geographical location, acting out a physical activity associated with a geographical location such as swimming at the beach or in a pool, etc. The first inputs may additionally and/or alternatively include body language and/or a mood of one or more of the participants. For example, in response to a determination that one of the participants is beginning to fall asleep during the VR collaboration session, it may be determined that the participant is bored and therefore it is time to output a second VR environment representation for display on the plurality of VR devices to regain an interest of the participant. A context of the first VR environment representation such as a subject of or conversation discussed during display of the first VR environment representation may be analyzed to determine whether to output a second VR environment representation for display on the plurality of VR devices. For example, in response to a determination that a portion of the conversation context discussing a geographical location that a second VR environment representation is based on exceeds a portion of the conversation context discussing a geographical location that a second VR environment representation is based on, it may be determined that the second VR environment representation should be output for display on the plurality of VR devices.

In some approaches, the dictionary of customized participant-specific inputs may be referenced, and entries therein may be compared with the received first inputs to determine whether to output the second VR environment representation for display on the plurality of VR devices. Accordingly, the analysis of user behavior, gestures, body language, etc., and determinations resulting therefrom may, at least in part, be based on the dictionary.

In response to a determination, based on the analysis, that a second VR environment representation should be output for display on the plurality of VR devices, the second VR environment representation and/or a transitional sequence for the VR devices to output while transitioning from displaying the first VR environment representation to displaying the second VR environment representation may be determined, e.g., see operation 210. Numerous examples of transitional sequences will now be described below.

In some approaches, the transitional sequence to be used for transitioning from the first VR environment representation to the second VR environment representation may include an object with the second VR environment representation depicted therein traversing across the first VR environment representation. In one example, such a transitional sequence may include bubbles being emitted from the mouth and/or a hand and/or a pocket of an avatar associated with one of the participants. Furthermore, in some approaches, a view of the second VR environment representation may be included in one or more of such bubbles. The transitional sequence may additionally and/or alternatively include objects of the second VR environment representation gradually populating the first VR environment representation. For example, flowers present in the second VR environment representation may gradually begin sprouting and blooming in the first VR environment representation in a transition from the first VR environment representation to the second VR environment representation. In yet another example, the transitional sequence may additionally and/or alternatively include objects of the second VR environment representation appearing in the first VR environment representation and gradually increasing in size, e.g., until the objects reach a size that the objects are to be depicted in the second VR environment representation.

In some approaches, the objects of the transitional sequence may be emitted by an avatar associated with one of the participants that is included in, e.g., appears in, the first VR environment representation. For example, this may, in one approach, include the bubbles transitional sequence mentioned above. In some other approaches, the objects of the transitional sequence being emitted by an avatar associated with one of the participants may, e.g., resemble sleight of hand tricks similar to how magicians make objects appear, come out of a pocket of clothing of one or the participants, appear from a hand opening, appear out of a container in the first VR environment representation, be aligned with a gesture of one of the participants, etc.

The first transitional sequence may, in some approaches, target sensory perceptions of the participants in addition to and/or other than sight and sound. For example, the transitional sequence may additionally and/or alternatively include a smell sample associated with the second VR environment representation being emitted by the VR devices. This sample may be emitted by such devices in response to a command being output to the VR devices to do so. A taste sample associated with the second VR environment representation may additionally and/or alternatively be emitted by the VR devices as the transitional sequence. Note that one or more of these types of samples may additionally and/or alternatively be caused to be emitted independent of the transition sequence, e.g., during display of the first VR environment representation to enhance the participant's sensory perception of the first VR environment representation.

In some approaches, the transitional sequence serves as a mere sensory transition to indicate that the second VR environment representation is replacing the first VR environment representation. However, it should be noted that, in some preferred approaches, the second VR environment representation is not guaranteed to be output for display on the plurality of VR devices in response to a determination based on analysis of the inputs received. Instead, in one or more of such approaches, the transitional sequence for the VR devices may be output for optional selection by the one or more participants. For example, in one or more of such approaches, the transitional sequence may serve as a trigger for replacing the first VR environment representation with the second VR environment representation. In continuation of the bubble transitional sequence example described elsewhere above in which a view of the second VR environment representation is included in one or more of such bubbles, a user gesture such as a tap gesture in a direction of one of the bubbles may serve as a selection that triggers transition from the first VR environment representation to the second VR environment representation. In contrast, in response to a determination that one or more of the participants have performed a second predetermined gesture and/or audible command associated with rejection of the second VR environment representation, the second VR environment representation may not be displayed on the VR devices. In some approaches, despite the rejection of the second VR environment representation, the transition sequence may continue to be displayed on one or more of the VR devices as an option that remains available for a predetermined amount of time. In some approaches, this predetermined amount of time may be output for display as a countdown on the display of the VR devices, and a command to stop displaying the transition sequence may be output in response to a determination that the predetermined amount of time has elapsed.

Operation 212 includes outputting the second VR environment representation and the transitional sequence for display on the VR devices. As the second VR environment representation is displayed in the VR devices, and a visual appeal of appearance of the first VR environment representation is stopped from being displayed in the VR devices, visual effects associated with the transitional sequence may be displayed for a predetermined amount of time. For example, while entering inside the second VR environment representation from the first VR environment representation, flowers may be displayed falling across a display of the VR devices and/or an associated sensory input may be emitted for the participants to consume. As the second VR environment representation transitions into display, the participants are able to visualize the second VR environment representation without actually being physically present at the second environment.

In some approaches, the second VR environment representation may include avatars, e.g., the avatars included in the first VR environment representation.

While the second VR environment representation is displayed on the VR devices, it may be determined whether another VR environment representation is to be displayed. For example, in some approaches a third VR environment representation may be displayed in response to one or more determinations described elsewhere herein being made with respect to the second VR environment representation and a third VR environment representation. In contrast, in some approaches, it may be determined whether to transition from a current VR environment representation, e.g., the second VR environment representation, to a previously displayed VR environment, e.g., the first VR environment representation. In one or more of such approaches, such a determination may be based on one or more of the participants performing a predetermined gesture and/or emitting a predetermined noise such as a predetermined spoken pattern. Accordingly, method 201 may include performing monitoring, e.g., for predetermined gestures being made by one or more of the participants, for predetermined audio being made by one or more of the participants, for a predetermined spoken pattern, for predetermined text input, etc., while the second VR environment representation is displayed on the VR devices. In response to a determination that one of the participants has performed a predetermined gesture and/or spoken pattern, a second transitional sequence for the VR devices to output while transitioning from the second VR environment representation back to the first VR environment representation may be output to the VR devices, e.g., see operation 214. In some approaches, the second transitional sequence may be related to a predetermined gesture performed by the participant. For example, in one approach, a first of the participants may swing their arm as if the first participant is holding a hammer and hammering something in front of them. In response to determining that the participant is making such a gesture, the transitional sequence may include an avatar associated with the first user displayed in the second VR environment representation being modified to be holding and swinging a hammer. Furthermore, as the avatar holds and swings the hammer, portions of the second VR environment representation may crack and/or shatter, and upon falling away reveal portions of the first VR environment representation. This transitional sequence may additionally and/or alternatively include an auditory effect of breaking glass, e.g., a shattering noise of a home window. The hammering may be performed any predetermined number of times until the first VR environment representation is fully displayed on the VR device, thereby replacing the second VR environment representation. In another approach, the transitional sequence may additionally and/or alternatively include a visual effect and/or an auditory effect of a balloon popping. For example, in response to a determination that a participant makes a predetermined poking gesture, an avatar associated with the participant may be shown popping a balloon (that depicts the first VR environment representation) in the second VR environment representation, and as the popping transitional sequence occurs, the first VR environment representation may be output for display on the VR devices. In yet another approach, the transitional sequence may additionally and/or alternatively include a visual effect of an avatar associated with the first participant throwing away the second VR environment representation. Thereafter the first VR environment representation may be output for display on the VR devices, which thereby removes the second VR environment representation from the first VR environment representation in the displays of the VR devices.

Numerous benefits are enabled as a result of implementing the techniques of various embodiments and approaches described herein. For example, as a result of dynamically modifying VR environment representations used in a VR collaboration session, participants of the VR collaboration session are relatively more engaged. Furthermore, the virtual experience offered as a result of the VR environment representations being changed according to gestures and contexts of the participants leads to relatively more productive meetings. This productivity ultimately reduces the amount of time that participants spend in meetings, which reduces the amount of computer processing performed and energy consumed. It should also be noted that dynamic modification of VR environment representations used in VR collaboration sessions has heretofore not been considered in conventional VR applications. Accordingly, the inventive discoveries disclosed herein with regards to use of such dynamic adjustments proceed contrary to conventional wisdom.

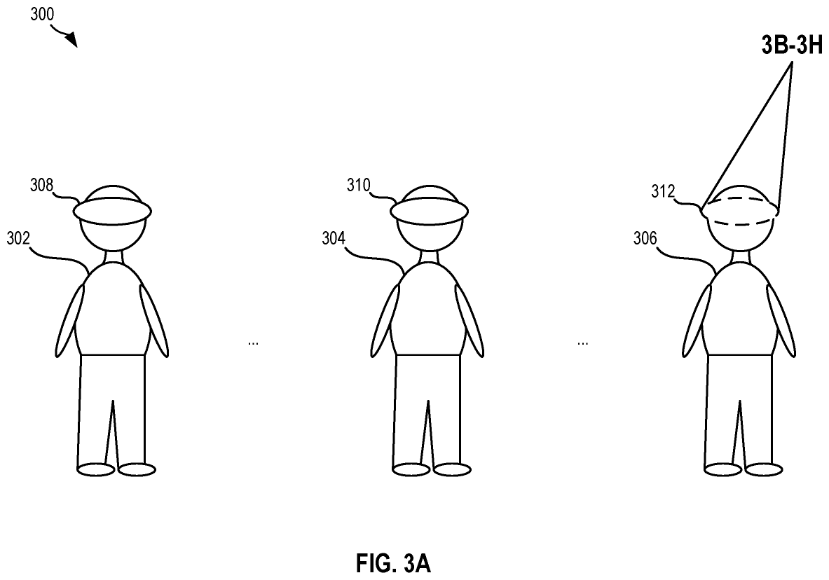

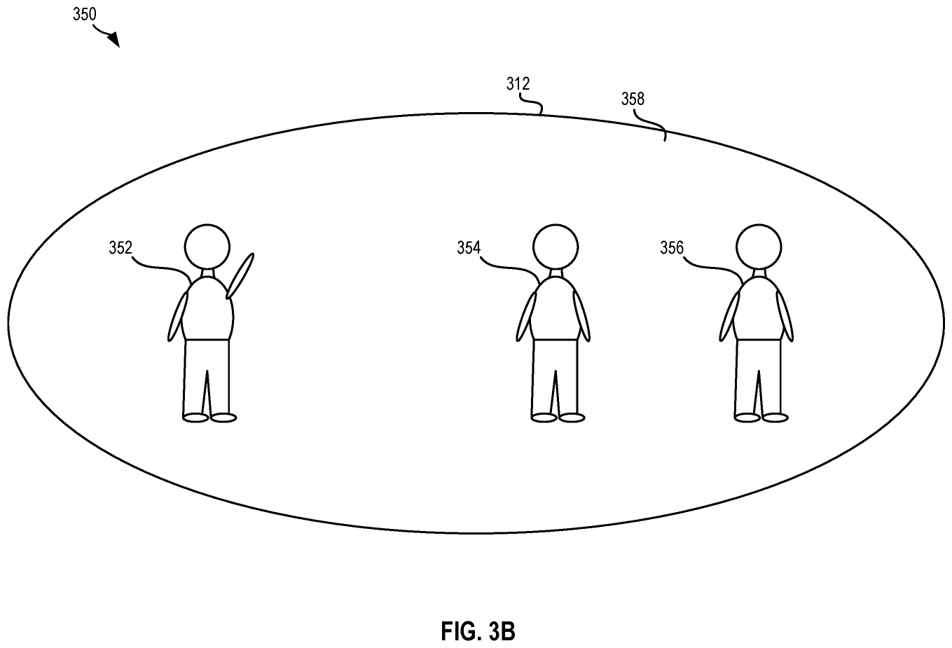

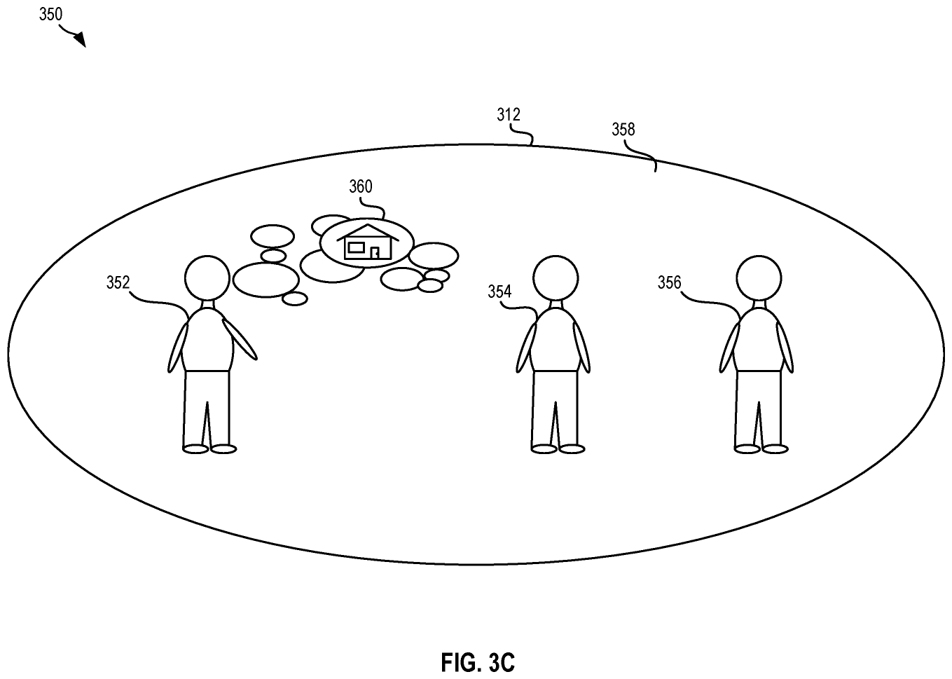

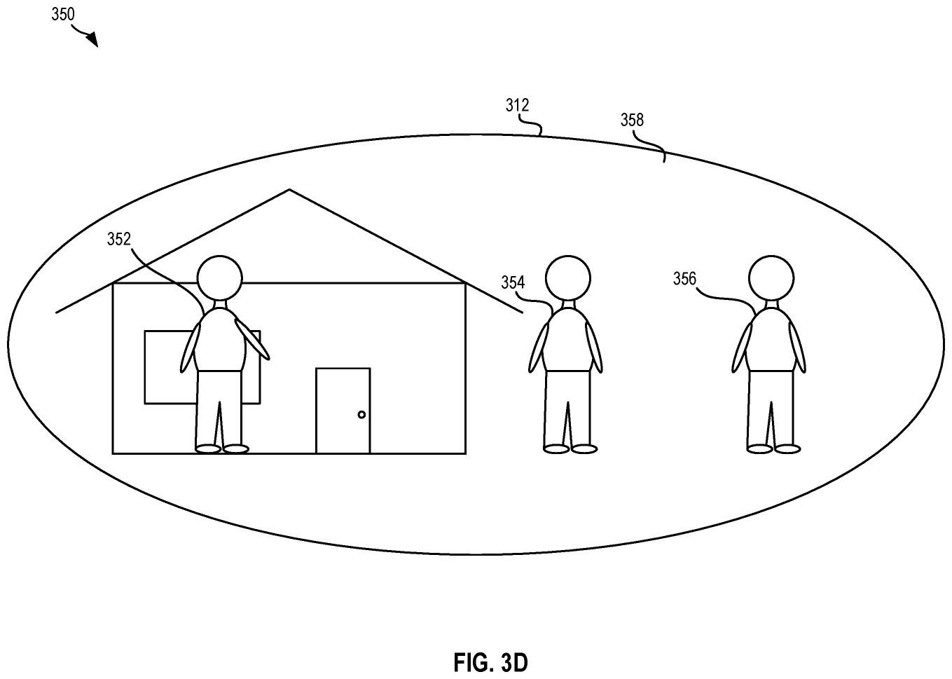

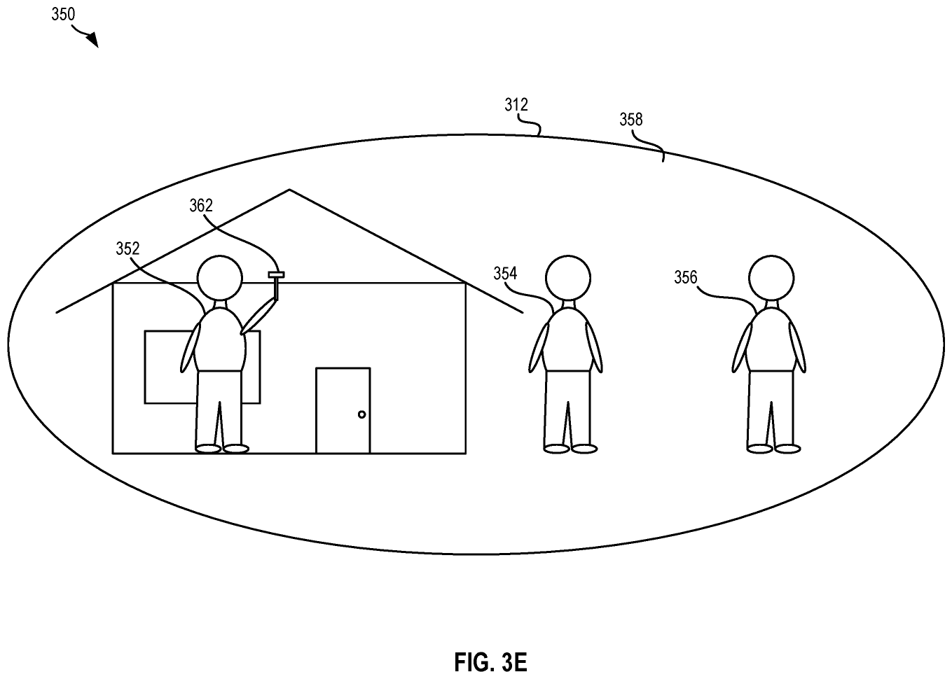

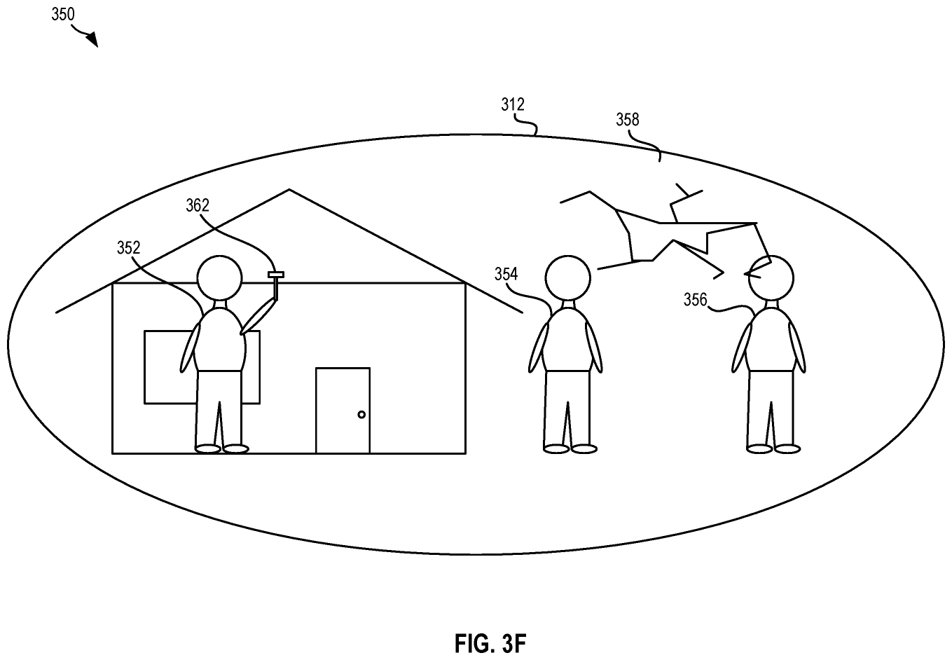

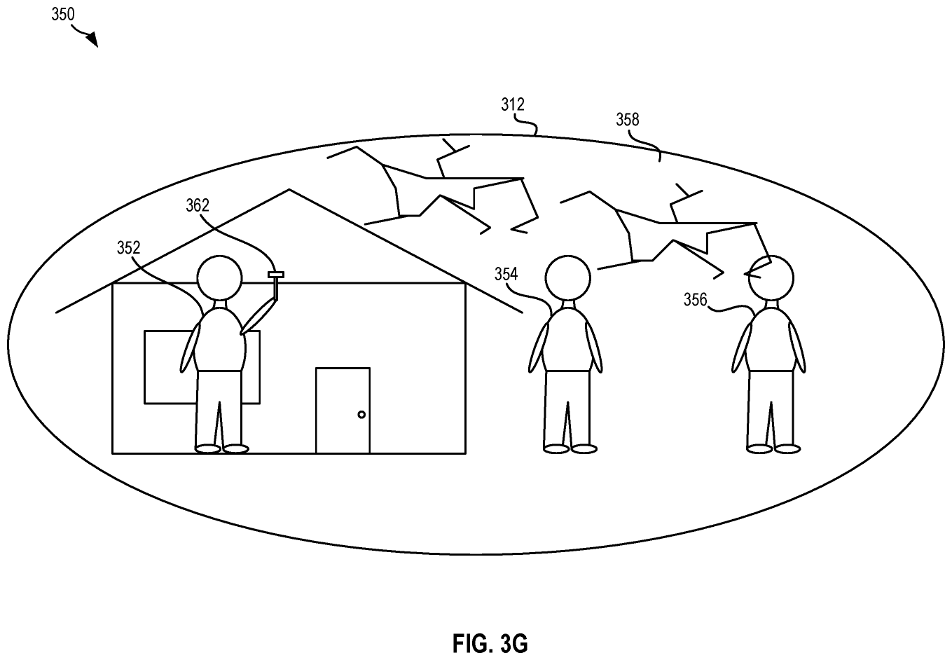

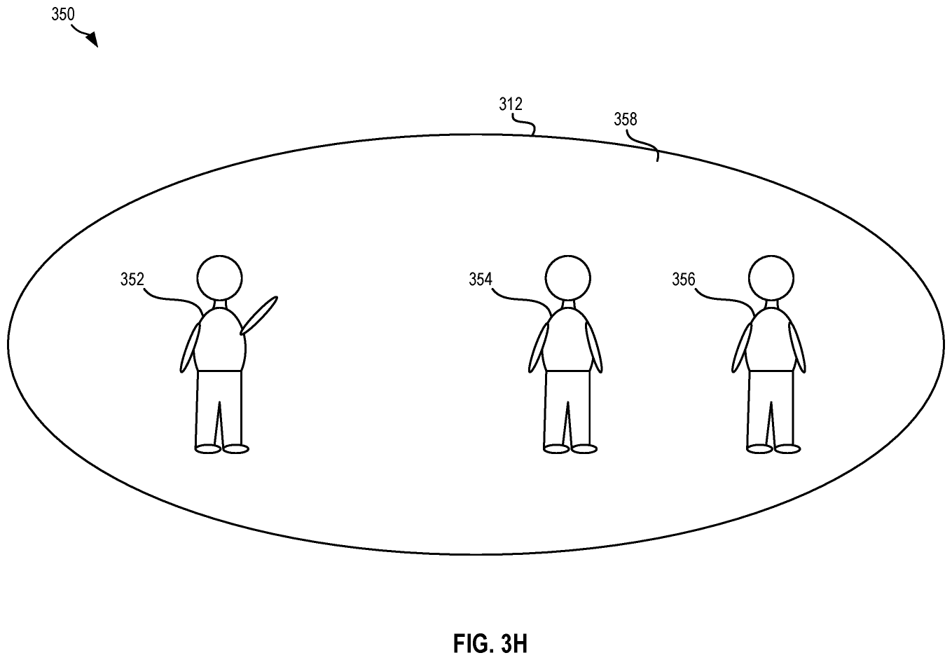

FIGS. 3A-3H depict representations 300, 350, in accordance with various embodiments. As an option, the present representations 300, 350 may be implemented in conjunction with features from any other embodiment listed herein, such as those described with reference to the other FIGS. Of course, however, such representations 300, 350 and others presented herein may be used in various applications and/or in permutations which may or may not be specifically described in the illustrative embodiments listed herein. Further, the representations 300, 350 presented herein may be used in any desired environment.

For context, FIGS. 3A-3H depict the representations 300, 350 of a VR collaboration session. More specifically, FIGS. 3A-3H illustrate a progression of a first VR environment representation being output to VR devices, a participant initiating a second VR environment representation to be output to the VR devices, based on a gesture, body language, etc., of the participant, a transition back to the first VR environment representation being displayed on the VR devices.

Referring first to FIG. 3A, representation 300 includes a plurality of human participants 302, 304 and 306, that are each wearing a respective VR device 308, 310 and 312. In some approaches, the VR devices include components to monitor the gestures and/or audio of the participants. Furthermore, the VR devices include components to emit sound, taste, smell, etc., samples for the participant to consume. A view of a display of the VR devices 308, 310 and 312 is illustrated in FIGS. 3B-3H.

Referring now to FIG. 3B, an output first VR environment representation is displayed on a display 358 of one of the VR devices. The first VR environment representation includes an avatar for each of the participants, e.g., see avatars 352, 354 and 356. Note that in some approaches, the VR devices are caused to display each of the avatars. In contrast, in some approaches, each of the VR devices are caused to display each of the avatars except an avatar associated with a participant using the VR device. In such an approach, a participant may as a result see the avatars associated with the other participants, but not their own avatar. During a collaboration session in the first VR environment representation, a context of the discussion may be identified. For example, inputs received from at least one of the participants during display of the first VR environment representation may be analyzed to determine whether to output a second VR environment representation for display on the VR devices. More specifically, this determination may be whether contents and/or digital contents of a second VR environment representation should be placed inside of contents and/or digital contents of the first VR environment representation.

In FIG. 3C, a first transitional sequence for potentially transitioning from the first VR environment representation to a second VR environment representation is output to the VR devices. For example, the first transitional sequence includes the first avatar 352 bubbles being emitted from the mouth the first avatar 352. Furthermore, it may be noted that a view of the second VR environment representation, e.g., a house that the participant associated with the avatar 352 is discussing is appears in and/or is depicted in one of the bubbles 360. Monitoring of the participants' gestures, body language, etc., continues to determine whether to bring about the second VR environment representation. This monitoring may include analyzing gesture(s) performed by the first participant, and determining a mapped virtual appearance. For example, in response to a determination that a user gesture, e.g., a tap gesture in a direction of one of the bubbles, has occurred, a transition from the first VR environment representation to the second VR environment representation may be performed. For example, in FIG. 3D the second VR environment representation is output for display on the display of the VR device.

Furthermore, each of the avatars are moved into the second VR environment representation displayed on the VR device. Here, the participants are able to visualize the second VR environment representation. In some approaches, the participants are able to visualize the second VR environment representation from an outside perspective, e.g., looking at the house, and/or can traverse within the second VR environment representation, e.g., open a door to the house and walk about inside the house. In response to a determination that one or more of the participants performed an action that is associated with the participant wanting to traverse within the second VR environment representation, additional extents of the second VR environment representation, e.g., an inside of the house, may be generated and output to the VR devices for display.

Referring now to FIG. 3E, it may be assumed that a determination is made that the participant associated with the avatar 352 has performed a predetermined gesture that is associated with dynamically returning to a previous VR environment representation. For example, in one approach, it may be determined that the participant is swinging their arm as if the participant is holding a hammer and hammering something in front of them. In response to determining that the participant is making such a gesture, a transitional sequence may be output to the VR device. The transitional sequence may include the avatar 352 displayed in the second VR environment representation being modified to be holding and swinging a hammer 362. As the avatar 352 is displayed holding and swinging the hammer 362, portions of the second VR environment representation may crack and/or shatter, and upon falling away and disappearing, reveal portions of the first VR environment representation, e.g., see FIGS. 3F-3G. This transitional sequence may additionally and/or alternatively include an auditory effect of breaking glass, e.g., a shattering noise of a home window. The hammering may be performed any predetermined number of times until the first VR environment representation is fully displayed on the VR device, e.g., see FIG. 3H thereby replacing the second VR environment representation.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
outputting a first virtual reality (VR) environment representation for display on a plurality of VR devices associated with a VR collaboration session, wherein each of the VR devices is used by a different participant of the VR collaboration session;
analyzing first inputs received from the participants to determine whether to output a second VR environment representation for display on the plurality of VR devices;
determining, based on the analysis, a second VR environment representation and a first transitional sequence for the VR devices to output while transitioning from displaying the first VR environment representation to displaying the second VR environment representation;
outputting the second VR environment representation and the first transitional sequence for display on the VR devices; and
in response to a determination that a first of the participants has performed a predetermined gesture, outputting a second transitional sequence for the VR devices to output while transitioning from the second VR environment representation back to the first VR environment representation.

2. The computer-implemented method of claim 1, wherein the first inputs are selected from the group consisting of: a gesture performed by one of the participants, an auditory spoken pattern, body language, a context of the first VR environment representation, a context of the second VR environment representation.

3. The computer-implemented method of claim 1, wherein the second transitional sequence is selected from the group consisting of: a visual effect of breaking glass, an auditory effect of breaking glass, a visual effect of a balloon popping, an auditory effect of a balloon popping, and a visual effect of an avatar associated with the first participant throwing away the second VR environment representation.

4. The computer-implemented method of claim 1, wherein the first transitional sequence is selected from the group consisting of: an object with the second VR environment representation depicted therein traversing across the first VR environment representation, objects of the second VR environment representation gradually populating the first VR environment representation, objects of the second VR environment representation appearing in the first VR environment representation and gradually increasing in size.

5. The computer-implemented method of claim 4, wherein the objects of the first transitional sequence are emitted by an avatar associated with one of the participants that is included in the first VR environment representation.

6. The computer-implemented method of claim 4, wherein the first transitional sequence is selected from the group consisting of: a smell sample associated with the second VR environment representation being emitted by the VR devices, and a taste sample associated with the second VR environment representation being emitted by the VR devices.

7. The computer-implemented method of claim 1, wherein the first VR environment representation includes an avatar for each of the participants, wherein the second VR environment representation includes the avatars.

8. The computer-implemented method of claim 7, wherein the avatars are cartoon representations based on a physical appearance of the participants, wherein the first VR environment representation is a real-world depiction of a geographical location.

9. The computer-implemented method of claim 1, comprising: receiving second inputs from the participants, wherein the second inputs define customized participant-specific inputs for initiating a currently displayed VR environment representation to be changed to a different VR environment representation; and building a dictionary of customized participant-specific inputs, wherein the analysis is, at least in part, based on the dictionary.

10. A computer program product, the computer program product comprising a computer readable storage medium having program instructions embodied therewith, the program instructions readable and/or executable by a computer to cause the computer to:
output, by the computer, a first virtual reality (VR) environment representation for display on a plurality of VR devices associated with a VR collaboration session, wherein each of the VR devices is used by a different participant of the VR collaboration session;
analyze, by the computer, first inputs received from the participants to determine whether to output a second VR environment representation for display on the plurality of VR devices;
determine, by the computer, based on the analysis, a second VR environment representation and a first transitional sequence for the VR devices to output while transitioning from displaying the first VR environment representation to displaying the second VR environment representation;
output, by the computer, the second VR environment representation and the first transitional sequence for display on the VR devices; and
in response to a determination that a first of the participants has performed a predetermined gesture, output, by the computer, a second transitional sequence for the VR devices to output while transitioning from the second VR environment representation back to the first VR environment representation.

11. The computer program product of claim 10, wherein the first inputs are selected from the group consisting of: a gesture performed by one of the participants, an auditory spoken pattern, body language, a context of the first VR environment representation, a context of the second VR environment representation.

12. The computer program product of claim 10, wherein the second transitional sequence is selected from the group consisting of: a visual effect of breaking glass, an auditory effect of breaking glass, a visual effect of a balloon popping, an auditory effect of a balloon popping, and a visual effect of an avatar associated with the first participant throwing away the second VR environment representation.

13. The computer program product of claim 10, wherein the first transitional sequence is selected from the group consisting of: an object with the second VR environment representation depicted therein traversing across the first VR environment representation, objects of the second VR environment representation gradually populating the first VR environment representation, objects of the second VR environment representation appearing in the first VR environment representation and gradually increasing in size.

14. The computer program product of claim 13, wherein the objects of the first transitional sequence are emitted by an avatar associated with one of the participants that is included in the first VR environment representation.

15. The computer program product of claim 13, wherein the first transitional sequence is selected from the group consisting of: a smell sample associated with the second VR environment representation being emitted by the VR devices, and a taste sample associated with the second VR environment representation being emitted by the VR devices.

16. The computer program product of claim 10, wherein the first VR environment representation includes an avatar for each of the participants, wherein the second VR environment representation includes the avatars.

17. The computer program product of claim 16, wherein the avatars are cartoon representations based on a physical appearance of the participants, wherein the first VR environment representation is a real-world depiction of a geographical location.

18. The computer program product of claim 10, the program instructions readable and/or executable by the computer to cause the computer to: receive, by the computer, second inputs from the participants, wherein the second inputs define customized participant-specific inputs for initiating a currently displayed VR environment representation to be changed to a different VR environment representation; and build, by the computer, a dictionary of customized participant-specific inputs, wherein the analysis is, at least in part, based on the dictionary.

19. A system, comprising:
a processor; and
logic integrated with the processor, executable by the processor, or integrated with and executable by the processor, the logic being configured to:
output a first virtual reality (VR) environment representation for display on a plurality of VR devices associated with a VR collaboration session, wherein each of the VR devices is used by a different participant of the VR collaboration session;
analyze first inputs received from the participants to determine whether to output a second VR environment representation for display on the plurality of VR devices;
determine, based on the analysis, a second VR environment representation and a first transitional sequence for the VR devices to output while transitioning from displaying the first VR environment representation to displaying the second VR environment representation;
output the second VR environment representation and the first transitional sequence for display on the VR devices; and
in response to a determination that a first of the participants has performed a predetermined gesture, output a second transitional sequence for the VR devices to output while transitioning from the second VR environment representation back to the first VR environment representation.

20. The system of claim 19, wherein the first inputs are selected from the group consisting of: a gesture performed by one of the participants, an auditory spoken pattern, body language, a context of the first VR environment representation, a context of the second VR environment representation.
